(19) United States
(12) Patent Application Publication
(10) Pub. No.: US 2008/0261265 A1
(43) Pub. Date: Oct. 23, 2008

(54) Histological staining composition and methods related thereto

(75) Inventors: Gorazd Rosoklija, New York, NY (US); Andrew J. Dwork, New York, NY (US)

Correspondence Address: SCHWEGMAN, LUNDBERG & WOESSNER, P.A., P.O. BOX 2938, MINNEAPOLIS, MN, 55402, US

(73) Assignee: The Trustees of Columbia University in the City of New York, new york, NY (US)

(21) Appl. No.: 12/005,030

(22) Filed: Dec. 20, 2007

Related U.S. Application Data
(60) Provisional application No. 60/875,991, filed on Dec. 20, 2006.

(51) Int. Cl. G01N 1/30

(52) U.S. Cl. 435/40.52

(57) ABSTRACT

Embodiments of the invention relate to a method for histological staining, the method comprises immersing a tissue sample in a staining solution sufficient to impregnate the tissue sample, dehydrating the tissue sample, embedding the tissue sample, cutting the tissue sample, developing the tissue sample, fixing the tissue sample and mounting the tissue sample. The staining solution comprises about 2.0×10⁻²M to about 6.0×10⁻²M potassium dichromate (K₂Cr₂O₇), about 2.4×10⁻²M to about 6.4×10⁻²M mercuric chloride (HgCl₂) and about 2.6×10⁻²M to about 7.8×10⁻²M potassium chromate (K₂CrO₄).

### CROSS-REFERENCE TO RELATED APPLICATIONS

This application claims priority benefit to U.S. Provisional Application No. 60/875,991, filed Dec. 20, 2006; the entirety of which is explicitly incorporated herein by reference.

### TECHNICAL FIELD

Embodiments of the present invention relate to compositions and methods for histological staining. More specifically, embodiments of the present invention relate to compositions and methods for staining nervous tissue.

### BACKGROUND

For a number of years, the Golgi stain technique (sometimes called the black reaction) has been used to stain nervous tissue and visualize cell structure. The cells in nervous tissue are densely packed and little information on their structures and interconnections can be obtained if all the cells are stained. The Golgi stain technique stains a limited number of cells randomly, thus allowing the slender or nearly transparent structures, such as axons and dendrites, to be clearly seen.

Although the Golgi stain technique allows for the visualization of nervous cells, the method has many drawbacks. Sometimes dozens of samples have to be stained in order to get a single sample that is usable, thereby wasting time and materials. Large areas of the sample may be unstained or stained too darkly, severely narrowing the sample sites a researcher may study.

### BRIEF DESCRIPTION OF THE DRAWINGS

The drawings illustrate generally, by way of example, but not by way of limitation, various embodiments discussed in the present document.

FIG. 1 illustrates a block flow diagram of a method of staining a tissue sample, according to some embodiments.

FIG. 2 illustrates a photograph of a stained section of the complete coronal section of human hippocampus, according to some embodiments.

FIGS. 3A-D illustrate photographs of a stained section of human subicular pyramidal neurons, according to some embodiments.

FIGS. 4A-E illustrate photographs of a stained section of a rat brain, according to some embodiments.

### SUMMARY OF THE INVENTION

Embodiments of the invention relate to a method for histological staining, the method comprises immersing a tissue sample in a staining solution sufficient to impregnate the tissue sample, dehydrating the tissue sample, embedding the tissue sample, cutting the tissue sample, developing the tissue sample, fixing the tissue sample and mounting the tissue sample. The staining solution comprises about 5.0×10⁻³M to about 1.5×10⁻²M potassium dichromate (K₂Cr₂O₇), about 6.0×10⁻³M to about 1.6×10⁻²M mercuric chloride (HgCl₂) and about 1.3×10⁻²M to about 3.9×10⁻²M potassium chromate (K₂CrO₄).

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense, and the scope of the present invention is defined by the appended claims and their equivalents.

In this document, the terms “a” or “an” are used to include one or more than one and the term “or” is used to refer to a nonexclusive “or” unless otherwise indicated. In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

Embodiments of the invention relate to a histological staining composition and methods related thereto. By using more dilute concentrations and longer impregnation times, the method allows for increased visibility, uniformity of staining and consistency not found in the prior art. In addition, the stained samples are more stable and can be stored for a significantly longer time period for future study.

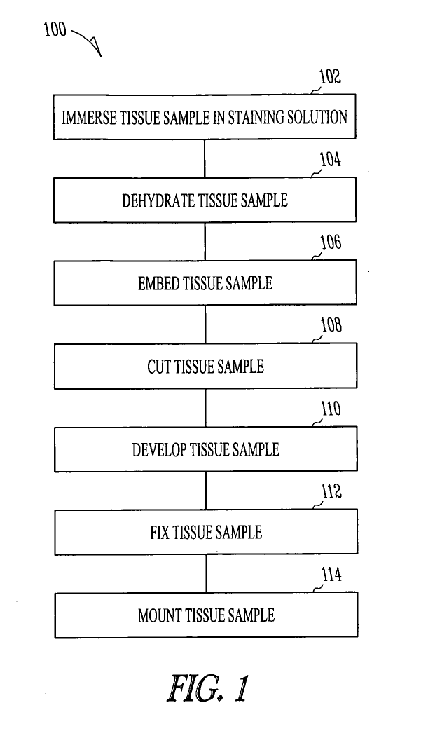

Referring to FIG. 1, a block flow diagram of a method 100 of staining a tissue sample is shown, according to some embodiments. A tissue sample may be immersed 102 in a staining solution. The tissue sample may then be dehydrated 104. The tissue sample may then be embedded 106. The tissue sample may be cut 108, developed 110 and fixed 112. Lastly, the tissue sample may be mounted 114.

The staining solution may be prepared from three stock solutions. The stock solutions may include dilute amounts of potassium chromate, potassium dichromate and mercuric chloride, for example. For example, a solution of about 5% by weight (about 17×10⁻² M) of potassium dichromate may be contacted with deionized water at a temperature suitable for the solute to substantially dissolve in the solution. An example temperature may be about 20° C. to about 40° C., or about 30° C. A solution of about 5% by weight (about 18.4×10⁻² M) mercuric chloride may be contacted with deionized water at a suitable temperature (about 95° C., for example). A third solution of about 2% by weight (10.3×10⁻² M) potassium chromate may be contacted with deionized water at a suitable temperature. About equal quantities of the first two solutions may be contacted and combined to form a mixture. The third solution may be contacted and combined with the mixture in an amount about equal to the total mixture volume, for example.

For example, about 1 L of each of the first two stock solutions may be added to about 2 L of the third solution. The contacting may include mixing, for example. After the dilution, the concentrations of the potassium dichromate in solution may be about 4.24×10⁻²M, the mercuric chloride solution may be about 4.6×10⁻² M and the potassium chromate solution may be about 5.3×10⁻²M, for example. The staining solution may be stored away from light, such as in a tinted or opaque container or bottle. The staining solution may be allowed to stand for a time sufficient for any particulate matter to settle out of solution. For example, the staining solution may be allowed to stand for about three days. Any precipitate or particulate matter found in the staining solution may be removed. For example, the staining solution may be decanted and filtered using Whatman N° 42 paper.

The starting amounts in the stock solutions may be varied. For example, the potassium dichromate may be present in the stock solution in amounts from about 3% to about 7% by weight. The potassium dichromate may be present in amounts from about 1% to about 3% by weight, from about 1.5% to about 2.5%, or from about 2.4% to about 2.6%, for example. The mercuric chloride may be present in an amount from about 3% to about 7% by weight, for example. The mercuric chloride may be present in an amount from about 3.6% to about 9% by weight, from about 4.4% to about 5.2%, or from about 4.8% to about 5%, for example. The potassium chromate may be present in an amount from about 2% to about 6% by weight, for example. The potassium chromate may be present in an amount from about 2.8% to about 5.2% by weight, from about 3.6% to about 4.4% or from about 3.8% to about 4.2%, for example.

In addition, the final solution concentrations of each component may be varied. For example, the potassium dichromate may be at a concentration of from about 2.5×10⁻²M to about 7.5×10⁻²M. The potassium dichromate may be at a concentration of from about 3.5×10⁻²M to about 6.5×10⁻²M, from about 4.5×10⁻²M to about 5.5×10⁻²M, or from about 4.75×10⁻²M to about 5.25×10⁻²M, for example. The mercuric chloride may be at a concentration of from about 2.4×10⁻²M to about 6.4×10⁻²M. The mercuric chloride may be at a concentration of from about 3.2×10⁻²M to about 5.6×10⁻²M, from about 4.0×10⁻²M to about 4.8×10⁻²M, or from about 4.2×10⁻²M to about 4.6×10⁻²M, for example. The potassium chromate may be at a concentration of from about 3.9×12M to about 1.17×10⁻¹M, for example. The potassium chromate may be at a concentration of from about 4.8×10⁻²M to about 1.08×10⁻¹M, from about 6.0×10⁻²M to about 9.6×10⁻²M or from about 6.9×10⁻²M to about 8.4×10⁻²M, for example. The amounts of potassium chromate and potassium dichromate may be varied so that only one of the two compounds may be used with mercuric chloride, for example.

Tissue samples may be cut from animal brains such as human, rodent or monkey brains, for example. The tissue samples may be cut into blocks, for example. The tissue samples may be fresh and/or unfixed. Whole rodent brains may also be used as tissue samples. Leptomeninges may be retained. Each tissue sample may be optionally wrapped in gauze and immersed 102 in the staining solution. Immersing 102 refers to contacting the tissue sample with staining solution. The volume of the staining solution may be of a sufficient amount to fully immerse the sample, such as about 100 times the volume of the tissue sample, for example. After about 24 hours, the staining solution, gauze and container may be replaced. The tissue sample in staining solution may be placed in the dark for a time sufficient to impregnate the tissue sample. The time may be about two months, about 2.5 months, about 3 months, about 6 months or about a year, for example. The tissue sample in staining solution may optionally be agitated or gently mixed, for example.

After a sufficient time to impregnate has passed, the tissue sample may be removed from the staining solution and dehydrated 104. During dehydration, the tissue sample may be optionally agitated or gently mixed. The tissue sample may be dehydrated in alcohol solutions. The alcohol solution volume may be sufficient to completely immerse the sample, such as about 100 times the volume of the sample, for example. The concentration of the alcohol solutions may be from about 40% to about 100%. The alcohol solutions may increase in concentration as the immersion time increases. For example, the tissue samples can be placed in a series of alcohol solutions that contain increasing amounts of alcohol to facilitate dehydration. In addition, ether may be introduced with the alcohol solution. For example, the tissue sample may be in contact with the following sequence of solutions: a 50% by volume alcohol solution for about 3 to about 24 hours, a 70% by volume alcohol solution for about 3 to about 24 hours, a 95% by volume alcohol solution for about 24 hours, another 95% by volume alcohol solution for about 24 hours, a 100% by volume alcohol solution for about 24 hours, another 100% by volume alcohol solution for about 24 hours, a 50% by volume alcohol in ether solution for about 24 hours and another 50% by volume alcohol in ether solution for about 24 hours, for example. Rat and mouse tissue samples may only require one washing with the ether solution and where the ether wash is for about 4 to about 24 hours.

After immersing with alcohol or ether, the tissue samples may be contacted with a nitrocellulose or nitrocellulose-type material, such as Parlodion®, for example. The nitrocellulose or nitrocellulose-type material may be in contact with the tissue sample for a number of days, such as about 12 days. The nitrocellulose-type material can be used in sequentially increasing an amounts ranging from about 2% to about 12%, for example.

The tissue sample may then be embedded 106. For example, the tissue sample may be placed in a paper boat and contacted with a nitrocellulose or nitrocellulose-type material solution. The tissue sample may be contacted with chloroform for a time sufficient for the tissue sample to harden. The tissue sample may then be softened, such as by being contacted with a solution of ethyl ether and ethanol, for example. The tissue sample may be contacted with an embedding block, such as a paraffin or phenolic resin embedding block. The tissue sample in contact with the embedding block (tissue block) may be contacted with a solution, mixture or compound in order to harden it, such as chloroform.

The tissue block may then be cut 108. The tissue block may be cut 108 using a microtome, for example. The thickness of the sections cut 108 may vary from about 30 microns to about 400 microns, for example. While cutting 108, the sections may be kept moist by applying paper wipes soaked with about a 70% alcohol solution. After cutting 108, each section may be placed in about a 70% solution of alcohol. The tissue sample sections may be developed immediately or stored for a short period of time (such as overnight) in a solution of about 70% alcohol, for example.

After cutting 108, the tissue sample sections may then be developed 110 and fixed 112. The tissue sample sections may be developed and fixed by being in contact with distilled water, ammonia solutions, fixer solution and ethanol, for example. The tissue sample sections may be washed with distilled water twice for about ten minutes each and then contacted with an about 19% ammonia solution for about 30 minutes. The tissue sample sections may be washed again with distilled water twice for about five minutes each and then contacted with a fixer solution for about ten minutes. The fixer solution may be Kodak Rapid Fix diluted 1:7, for example. The tissue sample sections may be washed again, twice for about five minutes each time. Some sections may be set aside for counterstaining at this point, such as with cresylecht violet, for example. The tissue sample sections may then be contacted with alcohol solutions of increasing concentration, such as 50%, 70% and 95% ethanol, for example. The tissue sample sections may then be contacted with two solutions of isopropyl alcohol and toluene, for example. Finally, the tissue sample sections may be mounted 114 on microscopic slides for viewing. The tissue sample sections may be mounted 114 using Permount®, for example. To prevent curling of the sections, a weight may be placed on the coverslip while the slide is allowed to dry. The slides may take weeks to dry, for example, about three weeks.

Although both the prior art methods and the methods of the embodiments of the present invention stain about 2-5% of the neurons in the tissue samples, the stained tissue samples of the present invention may show a near uniformity of staining. Previous methods stained random sections with varying degrees of clarity. The slides produced by the present embodiments have little to no artifacts obstructing the clarity and show a consistent view across the entire sample. This may allow for greater scientific validity in studies, as more samples can be utilized and a random selection of samples or areas within the samples can be compared. Previously, many slides would be thrown out as unusable and only a small selection of slides or areas of tissue could be studied. Previously made slides were also unstable and could only be used for a limited number of months, usually less than six. The tissue sample slides produced by the current method do not darken or decompose for more than two years. Thicker sections of tissue may be studied as well, due to the uniformity, consistency and specificity in staining. The depth of the tissue sample may only be limited by microscope optics. Individual neurons can be traced and studied with superior results.

### EXAMPLE

The staining solution was prepared from three stock solutions:

Stock solution #1 K₂Cr₂O₇ (5%) dissolved in deionized water warmed to 30° C.
Stock solution #2 HgCl₂ (5%) dissolved in deionized water warmed to 95° C.
Stock solution #3 K₂CrO₄ (2%) dissolved in cold deionized water.

Equal quantities of stock solutions 1 and 2 are mixed, constituting 50% of the total volume of the staining solution, and then added to stock solution 3, which constitutes the remaining 50% of the total volume of the staining solution. For example: 1 L stock solution #1+1 L stock solution #2+2 L stock solution #3.

A brown glass bottle was used to shield the final staining solution from light. The mixed solution was allowed to stand for 3 days to allow particulate matter to settle. The supernatant was decanted and filtered through Whatman N° 42 paper.

Blocks of tissue approximately 4×10×10 mm were cut from fresh, unfixed human and monkey brain. Unfixed rodent brains were used whole. There was no need to remove leptomeninges. Each tissue block was wrapped in clean gauze and immersed in staining solution (˜100 times the volume of the tissue). After 24 hours, staining solution, gauze and bottle were changed. The containers with the tissue blocks were kept in the dark, on a shaker for 2.5 months. If human tissue is left for longer than 2.5 months, for example, up to one year, the quality of impregnation is not affected. If rat or mouse tissue is left more than 2.5 months, the number of impregnated blood vessels will increase.

The tissue was removed from the staining solution and dehydrated by agitation in about 100 times the volume of the tissue using the following sequence of solutions:

50% alcohol for 24 hr

70% alcohol for 24 hr

95% alcohol for 24 hr

95% alcohol for 24 hr

100% alcohol for 24 hr

100% alcohol for 24 hr

1:1 100% alcohol+ether 24 hr

1:1 100% alcohol+ether 24 hr

(Rat and mouse brains were treated with only one washing in 1:1 100%
alcohol+ether over 24 hours)

2% Parlodion® for 3 days

4% Parlodion® for 3 days

8% Parlodion® for 3 days

12% Parlodion® for 3 days

A paper boat was constructed that was slightly larger in size than the tissue block to be embedded. A small amount of 12% Parlodion® was added to the paper boat (filled about ½ inches deep), tissue was placed in the boat, and 12% Parlodion® was added to fill up the boat. The boat was placed in a jar with chloroform covering only the bottom of the boat (½ inch). The lid was sealed with parafilm and left for 6 to 16 hours to harden.

The hardened blocks were removed from the chloroform. The Parlodion® was trimmed with a razor blade to a size slightly larger than the tissue. The bottom side was scored with a razor blade and the scored side was placed into a small amount of 1:1 ethyl ether:ethanol to soften. A paper collar was taped around a phenolic resin embedding block (e.g. Thomas Scientific catalog no. 6755B25) that extended about 1 inch above the surface of the embedding block. The collar was labeled with the block name in pencil. A little 12% Parlodion® was poured onto the surface of the chuck and the softened surface of the block was pressed onto the chuck using hard, even pressure. The entire unit was placed back into the jar with chloroform to harden for 6 to 16 hours. The chloroform level in the jar was such that the Parlodion® and tissue were exposed to the chloroform vapor but not immersed in the liquid.

The tissue block was placed on a sliding microtome. Thickness of the sections were from 30μ up to 400μ. Sections were placed in 70% alcohol. During the cutting, tissue block was kept wet by applying paper wipes soaked in 70% alcohol, after each section. The cut sections can be processed immediately or kept overnight in 70% ethanol.

The sections were processed in the following manner:

Sections were collected in 70% ethanol.
Distilled water (DW) 2 times for 10 min, each time.
Ammonia water (19% NH₄OH) for 30 min in closed vessel
DW 2 times for 5 min each time.
Fixer (Kodak Rapid Fix diluted 1:7) for 10 min
DW 2 times for 5 min each time.

Some tissue sections were set aside for counterstaining with cresylecht violet. The tissue samples were then processed in the following manner:

50% ethanol for 5 min
70% ethanol for 5 min
95% ethanol for 2 times for 5 min each time
Two changes of isopropyl alcohol (2-propanol) for 5 min each
Two changes of toluene for 5 min each
The sections were mounted on microscopic slides using Permount®.
To prevent curling of the sections, a 115 g lead weight was placed on each glass coverslip, and the slides were allowed to dry for 3 weeks.

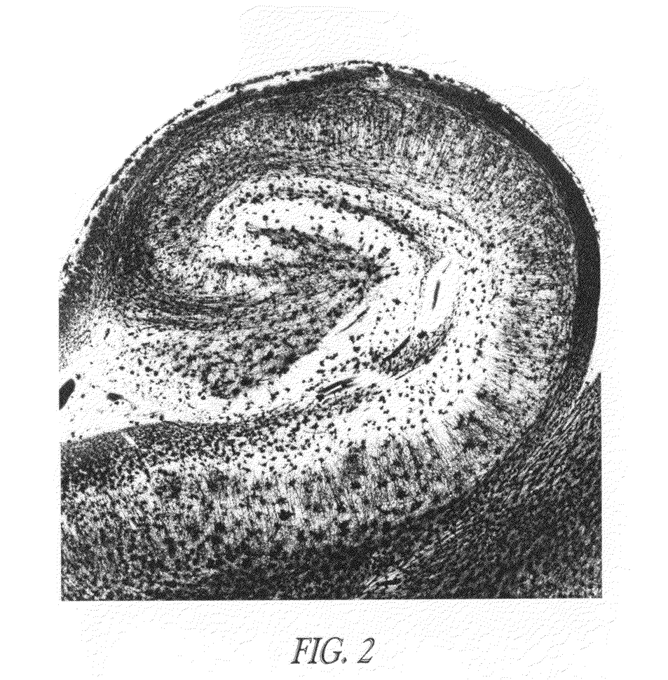

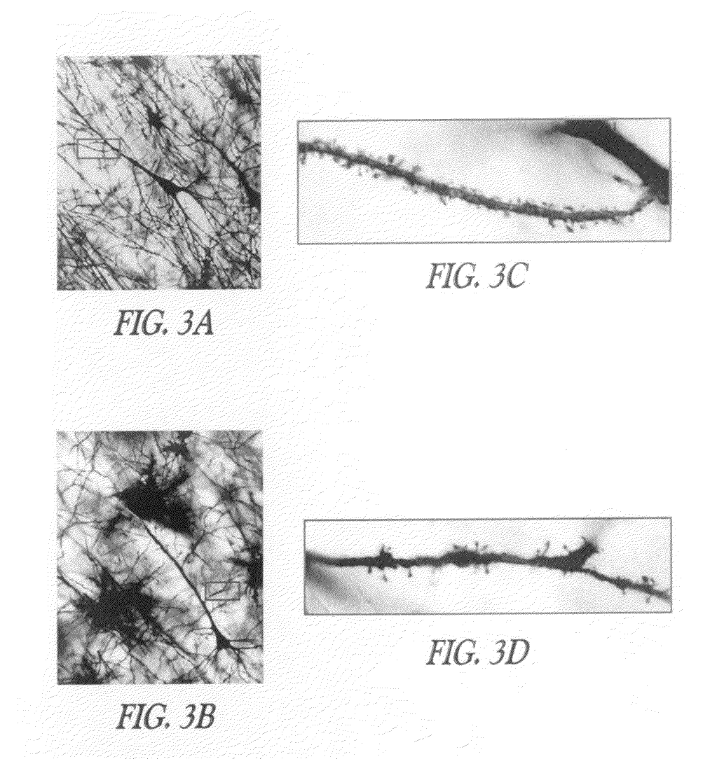

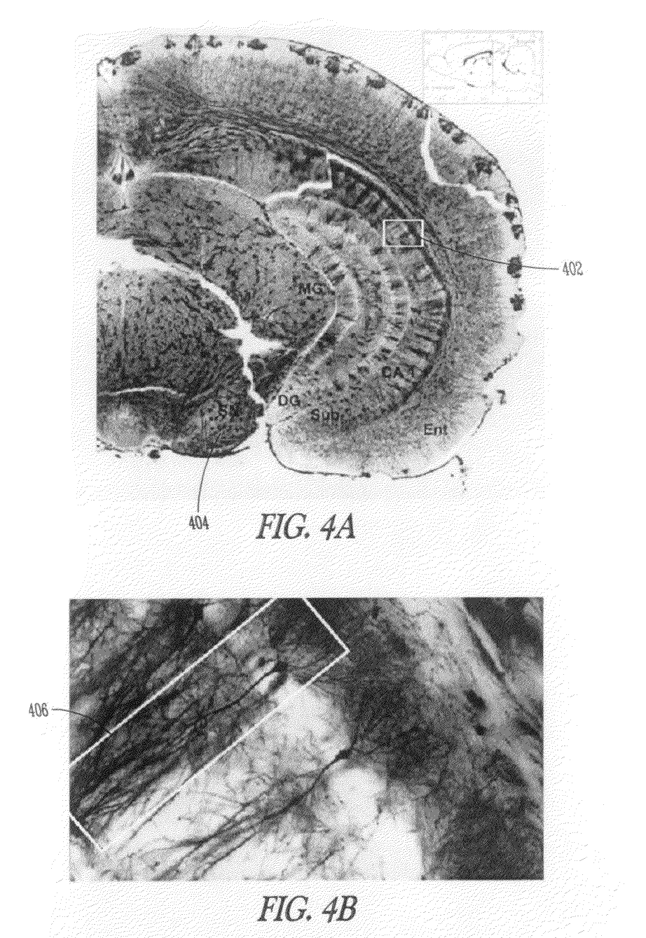

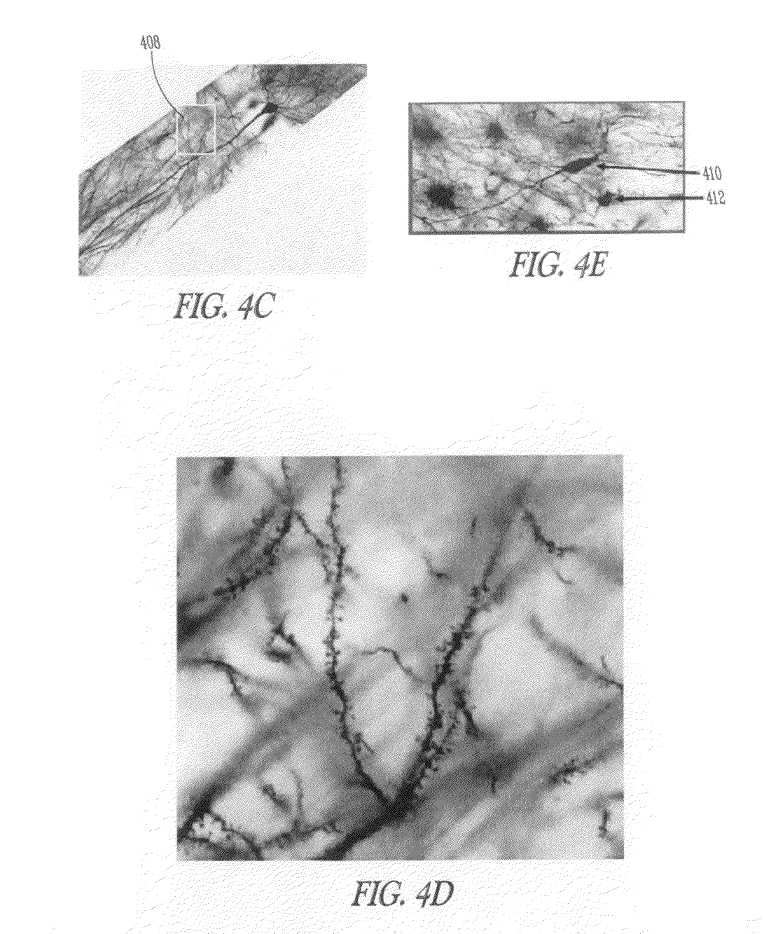

Referring to FIG. 2, a photograph of a stained section of the complete coronal section of human hippocampus is shown, according to some embodiments. The significant clarity and consistency of staining is clearly exemplified. FIGS. 3A-D illustrate photographs of a stained section of subicular pyramidal neurons, according to some embodiments. FIGS. 3A and 3C are from a case with normal spine density. FIGS. 3B and 3D are from a case with pathologically diminished spine density. Both FIGS. 3C and 3D are views at higher magnification of the regions indicated in FIGS. 3A and 3B, respectively. FIGS. 4A-E illustrate photographs of a stained section of a rat brain, according to some embodiments. FIG. 4A shows one hemisphere of a coronal section of an adult female rat at the level of the caudal hippocampus and midbrain. As indicated on the photograph, MG refers to medial geniculate body, SN refers to Substantia Nigra (posterior), DG refers to Dentate Gyrus, Ent refers to entorhinal cortex, CA1 refers to ventral CA1 of the hippocampus and Sub refers to ventral subiculum (where the cell clusters spread out into several disorganized layers), respectively. FIG. 4B shows a higher magnification of the section 402 indicated in FIG. 4A. FIG. 4C shows a higher magnification of the section 406 indicated in FIG. 4B. FIG. 4D shows a higher magnification of the section 408 indicated in FIG. 4C, displaying 2nd-order dendrites off the apical dendrites with spines). FIG. 4E shows a higher magnification of a dopaminergic neuron 410 and a GABA neuron 412 (smaller and round) in the Substantia Nigra of the indicated section in FIG. 4A.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

What is claimed is:

1. A method for histological staining, the method comprising:
immersing a tissue sample in a staining solution, sufficient to impregnate the tissue sample, the staining solution comprising:
about 5.0×10⁻³M to about 4.24×10⁻²M potassium dichromate (K₂Cr₂O₇);
about 6.0×10⁻³M to about 4.6×10⁻²M mercuric chloride (HgCl₂); and
about 1.3×10⁻²M to about 5.15×10⁻²M potassium chromate (K₂CrO₄);
dehydrating the tissue sample;
embedding the tissue sample;
cutting the tissue sample;
developing the tissue sample;
fixing the tissue sample; and
mounting the tissue sample.

2. The method of claim 1, wherein the amount of potassium dichromate comprises from about 7.0×10⁻³M to about 1.3×10⁻²M.

3. The method of claim 1, wherein the amount of potassium dichromate comprises from about 2.0×10⁻²M to about 3.1×10⁻²M.

4. The method of claim 1, wherein the amount of potassium dichromate comprises from about 2.6×10⁻²M to about 3.1×10⁻²M.

5. The method of claim 1, wherein the amount of mercuric chloride comprises from about 2.6×10⁻²M to about 3.2×10⁻²M.

6. The method of claim 1, wherein the amount of mercuric chloride comprises from about 2.3×10⁻²M to about 4.1×10⁻²M.

7. The method of claim 1, wherein the amount of mercuric chloride comprises from about 2.9×10⁻²M to about 3.5×10⁻²M.

8. The method of claim 1, wherein the amount of potassium chromate comprises from about 2.1×10⁻²M to about 4.7×10⁻²M.

9. The method of claim 1, wherein the amount of potassium chromate comprises from about 2.6×10⁻²M to about 4.2×10⁻²M.

10. The method of claim 1, wherein the amount of potassium chromate comprises from about 3.0×10⁻²M to about 3.6×10⁻²M

11. The method of claim 1, wherein impregnation of the tissue sample comprises immersing for about two months.

12. The method of claim 1, wherein impregnation of the tissue sample comprises immersing for about 2.5 months.

13. The method of claim 1, wherein impregnation of the tissue sample comprises immersing for about 3 months.

14. The method of claim 1, wherein impregnation of the tissue sample comprises immersing for about 6 months.

15. The method of claim 1, wherein impregnation of the tissue sample comprises immersing for about 12 months.

16. The method of claim 1, wherein dehydrating comprises contacting the tissue sample with alcohol solutions.

17. The method of claim 1, wherein dehydrating comprises contacting the tissue sample with alcohol and ether solutions.

18. The method of claim 1, wherein dehydrating comprises contacting the tissue sample with solutions of alcohol, ether and nitrocellulose-type material.

19. The method of claim 1, wherein cutting comprises cutting the tissue block into tissue sample sections.

20. The method of claim 19, wherein the tissue sample sections are from about 30 microns to about 400 microns thick.

21. A method for histological staining, the method comprising:
immersing a tissue sample in a staining solution, sufficient to impregnate the tissue sample, the staining solution comprising:
about 2.8×10⁻²M potassium dichromate (K₂Cr₂O₇);
about 2.9×10⁻²M mercuric chloride (HgCl₂); and
about 3.5×10⁻²M potassium chromate (K₂CrO₄);
dehydrating the tissue sample;
embedding the tissue sample;
cutting the tissue sample, sufficient to provide tissue sample sections from about 30 microns to about 400 microns thick;
developing the tissue sample;
fixing the tissue sample; and
mounting the tissue sample;
wherein the tissue sample has substantially uniform staining.

22. A histological staining composition comprising:
about 1.4×10⁻²M to about 4.2×10⁻²M potassium dichromate (K₂Cr₂O₇);
about 1.9×10⁻²M to about 4.6×10⁻²M mercuric chloride (HgCl₂); and
about 1.7×10⁻²M to about 5.1×10⁻²M potassium chromate (K₂CrO₄).
